(19) United States
(12) Patent Application Publication
(10) Pub. No.: US 2026/0366343 A1
(43) Pub. Date: Nov. 19, 2026

(54) OPENING MECHANISM FOR A VEHICLE DOOR AND METHOD FOR ACTUATING AN EMERGENCY UNLOCKING MEANS OF AN OPENING MECHANISM

(71) Applicant: H+E Molding Solutions GmbH, Ittlingen (DE)

(72) Inventor: Milto BENJAMIN, Gütersloh (DE)

(73) Assignee: H+E Molding Solutions GmbH, Ittlingen (DE)

(21) Appl. No.: 19/132,466

(22) PCT Filed: Nov. 17, 2023
(86) PCT No.: PCT/EP2023/082195

§ 371 Date: May 23, 2025

(30) Foreign Application Priority Data
Nov. 25, 2022 (DE) 10 2022 131 291.7

(51) Int. Cl. E05B 81/90; E05B 79/20

(52) U.S. Cl. CPC E05B 81/90; E05B 79/20

(57) ABSTRACT

An opening mechanism for a vehicle door includes a bearing element mounted on the vehicle door, a pivotably mounted lever, a microswitch for unlocking a door lock and a mechanical emergency unlocking means for unlocking the door lock. The lever is pretensioned into a starting position and actuates the microswitch in a first pivot position and actuates the mechanical emergency unlocking means in a second pivot position, The first pivot position of the lever is arranged between the starting position and the second pivot position. A force threshold device is provided for increasing the force for pivoting the lever from the first pivot position to the second pivot position, and includes a wire clamp and a driver which can be moved relative to the wire clamp. To increase the force by way of the force threshold device, the driver can be guided through a narrowed region at the wire clamp.

The present invention relates to an opening mechanism for a vehicle door having a bearing element which can be mounted on the vehicle door and has a pivotably mounted lever, a microswitch for unlocking a door lock and a mechanical emergency unlocking means for unlocking the door lock, wherein the lever, which is pretensioned into a starting position, actuates the microswitch in a first pivot position and actuates the mechanical emergency unlocking means in a second pivot position, and the first pivot position of the lever is arranged between the starting position and the second pivot position, and a force threshold device, by means of which the force for pivoting the lever from the first pivot position to the second pivot position is increased, which comprises a wire clamp and a driver movable relative to the wire clamp, and a method for actuating an emergency unlocking means of an opening mechanism on a vehicle door.

DE 10 2019 207 511 B4 discloses a door handle arrangement for a vehicle door in which a door handle can be pivoted from a recessed position into an emergency unlocking position. This emergency unlocking may be necessary if electromechanical unlocking cannot be carried out, for example because a minimum voltage is not present in a vehicle electrical system or due to an accident. To prevent the user from pivoting the door handle from the position for electromechanical unlocking to an emergency unlocking position, a force threshold device can be provided which ensures that the force required to pivot the door handle between the two positions is increased. Such force threshold devices are often complex in design and not very precise with regard to the pressure point, i.e. the point that is required in terms of the force required to pivot the door handle further into the position for emergency unlocking.

It is therefore the object of the present invention to create an opening mechanism for a vehicle door and a method for actuating an emergency unlocking means, which provides a force threshold device by simple means, which has a comparatively precise pressure point.

This object is solved by an opening mechanism having the features of claim 1 and a method having the features of claim 15.

The opening mechanism comprises a lever pivotably mounted on a bearing element, which can be moved from a starting position into a first pivot position for actuating a microswitch and can be moved further from this first pivot position into a second pivot position for a mechanical emergency unlocking means. Between the first pivot position and the second pivot position, a force threshold device is provided which increases the force for pivoting the lever into the position of the emergency unlocking means, which comprises a wire clamp and a driver movable relative to the wire clamp. As a result, the simple interaction between the wire clamp and the driver can increase the force for performing the pivoting movement from the first to the second pivot position. The wire clamp enables a comparatively precise adjustment of the pressure point, as an expanding movement of the wire clamp at the narrowed region takes place according to precise geometric specifications when the driver is passed through, in particular with regard to the lever ratios on the wire clamp and the thickness of the wire from which the wire clamp is made.

Preferably, the force for moving the lever through the force threshold device is at least three times as high as when moving to the first pivot position. This allows the user to initially move the lever smoothly to the first pivot position to unlock the door lock via the microswitch. If this does not result in the door lock being opened for any reason, the user can increase the force required to move the lever further into the emergency unlocking position, wherein the force threshold device provides a tactile distinction between the individual positions, in which the force required to move the lever is at least three times, preferably at least four times, as high as during the previous pivoting movement.

With the wire clamp, the narrowed region preferably has a smaller distance than the thickness of the driver. The driver thus ensures that the wire clamp is spread open and reproducible force ratios are achieved when passing through the narrowed region. The wire clamp can, for example, be shaped into an Q, wherein the narrowed region can be formed by U-or V-shaped sections of the wire clamp. The wire clamp is preferably made of a round wire, but can also be produced using other wire geometries in an oval, square or rectangular shape. Preferably, a metal wire made of steel is used.

A ramp with a guide bevel is preferably arranged adjacent to the driver on the force threshold device, by means of which the wire clamp can be moved perpendicularly to the direction of movement of the driver. This means that a different force may be required to pivot the lever in the opening direction than for a backward pivoting movement, as the position of the wire clamp can be changed via the ramp. Preferably, the wire clamp is disengaged from the driver via the ramp, and the driver is not passed through the narrowed region during a return movement from the second pivot position to the first pivot position. As a result, a spring for the lever can move it smoothly and automatically from the second pivot position to the starting position without the force threshold device also providing increased force during the return movement.

The driver is preferably designed as a pin, bolt, tube or projection, optionally also integral with the lever or the bearing element. Preferably, the driver is made of metal or is coated with metal or another sliding material so that low frictional forces act when the driver moves relative to the wire clamp.

In a preferred design, the wire clamp is fixed to the bearing element and the driver is fixed to the lever. This results in a particularly compact design, as the driver can be integrated into the contour of the lever. Alternatively, it is of course also possible to fix the wire clamp to the lever and the driver to the bearing element.

The wire clamp is preferably pretensioned towards the lever so that the wire clamp is lifted by the guide bevel of the ramp against the force of the pretension. This ensures that the wire clamp is moved back to its starting position when the ramp is removed.

The microswitch is fixed to the bearing element for a compact design and interacts with a cam, which is arranged or integrally formed on the lever. The microswitch can be connected to the door lock via a control line in order to open it electromechanically.

The lever is preferably connected to the emergency unlocking means via a transmission member. The transmission member can, for example, be a tension element, such as a Bowden cable, in order to effect mechanical unlocking via this.

For a stable fixation of the wire clamp, it can have a bent pin at each of its free ends, which is inserted into a receptacle of the bearing element. The two pins can form an axis of rotation about which the wire clamp can be pivoted during assembly, wherein the wire clamp can preferably be latched to a latching recess on the receptacle; preferably, the latching receptacle can be used to pretension the wire clamp towards the lever. For this purpose, a bevel can be formed on the latching receptacle, which acts on one leg of the wire clamp.

For a space-saving design, the lever is designed as a two-armed lever and comprises a grip section and a control section, which are arranged on different sides of an axis of rotation of the lever. Optionally, the lever can also perform a combined rotary and sliding movement rather than a pure rotary movement.

The opening mechanism according to the invention is preferably used in a vehicle in which a vehicle door is to be unlocked. The lever is preferably the opening lever on the inside of the vehicle door.

In the method according to the invention for actuating an emergency unlocking means of an opening mechanism, a lever pivotably mounted on a bearing element is first pivoted from a starting position against the force of a spring into a first pivot position at which a microswitch for unlocking a door lock can be switched. For this purpose, the lever can be pivoted at an angle of between 10° and 30°, for example. However, the microswitch is not used to unlock the door lock, for example due to a lack of voltage or an accident. The lever is then pivoted from the first pivot position to a force threshold device with a wire clamp and a driver that can be moved relative to the wire clamp, wherein the driver has a narrowed region to increase the resistance when the lever is pivoted, through which the driver is passed and which expands when the driver is passed through. The lever is then pivoted from the force threshold device to a second pivot position in order to actuate a mechanical emergency unlocking means for unlocking the door lock.

The invention is explained in more detail below by means of an exemplary embodiment with reference to the accompanying drawings, wherein:

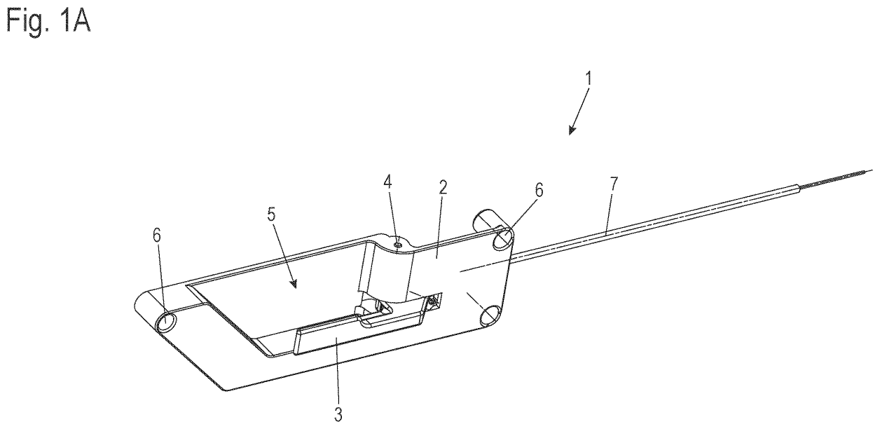

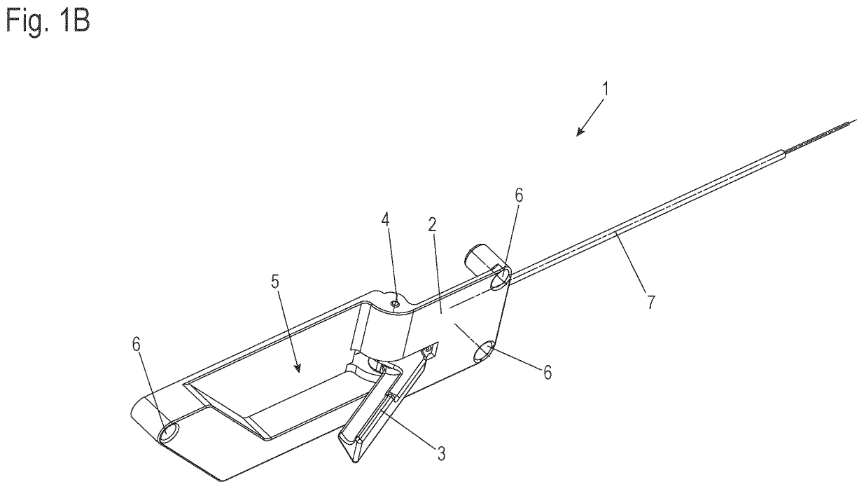

FIGS. 1A and 1B show two views of an opening mechanism according to the invention in different positions;

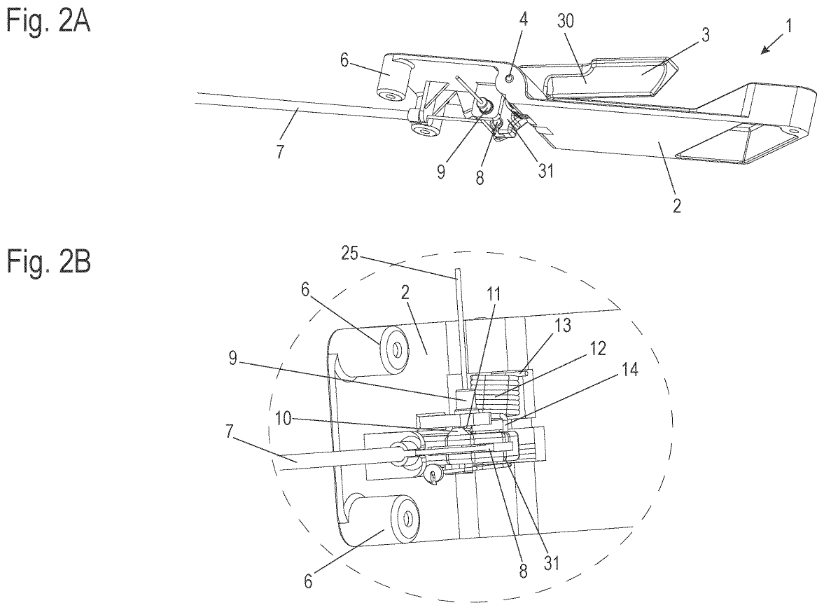

FIGS. 2A and 2B show two views of the opening mechanism with a slightly

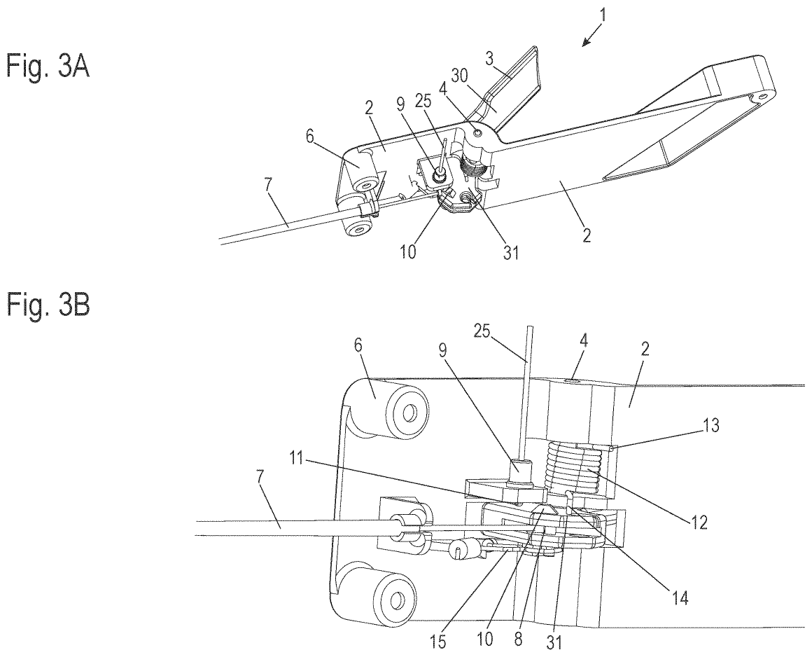

FIGS. 3A and 3B show two views of the opening mechanism in an emergency unlocking position;

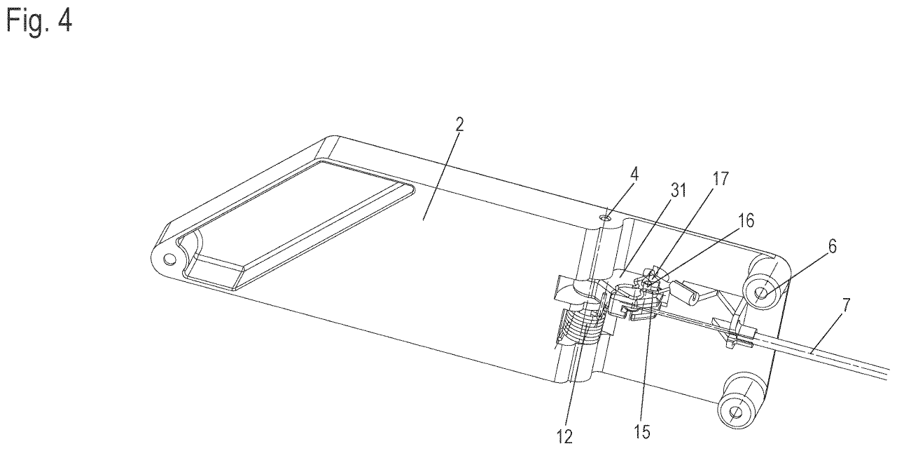

FIG. 4 shows a perspective view of the opening mechanism from an underside;

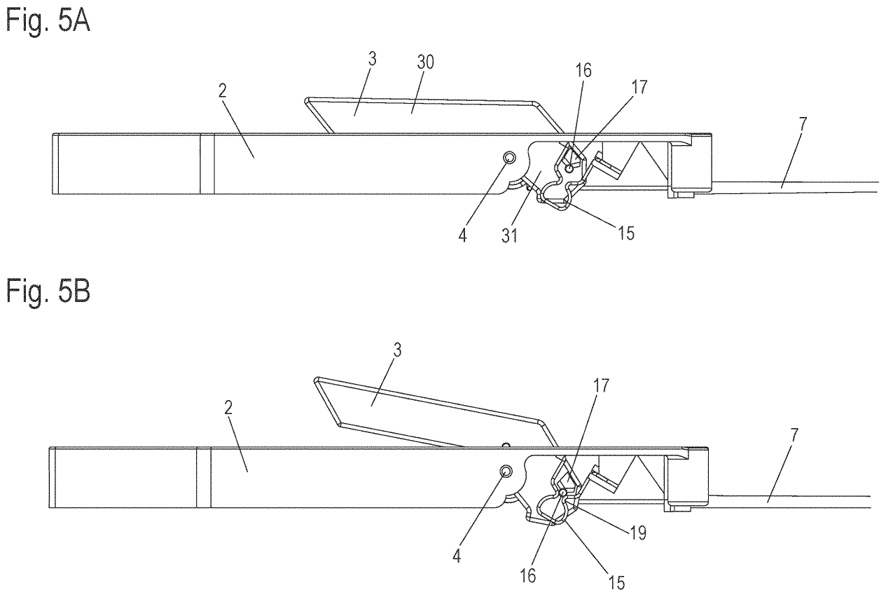

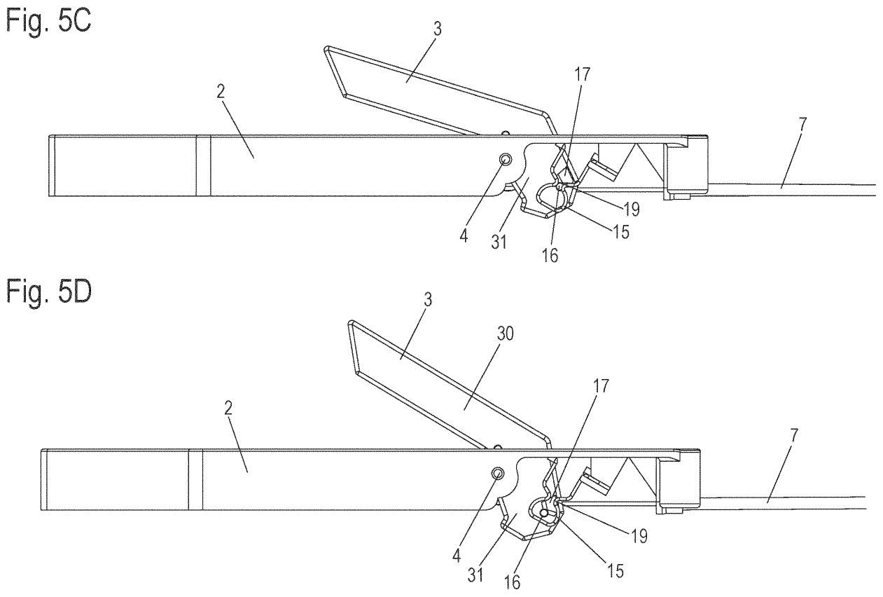

FIGS. 5A to 5D show several views of the force threshold device of the opening mechanism in different positions;

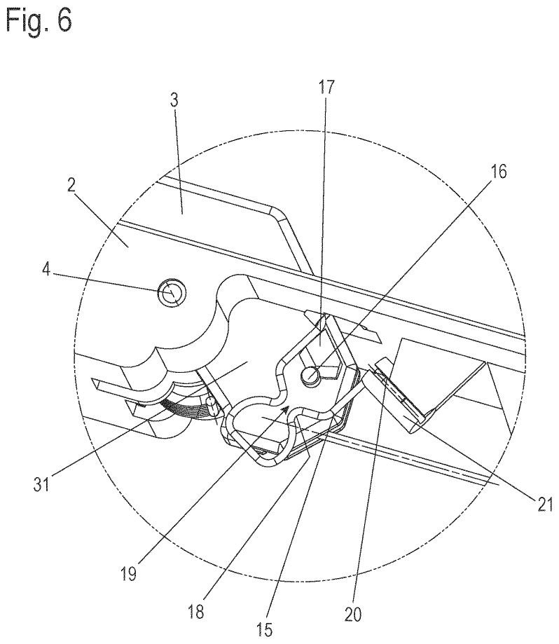

FIG. 6 shows a detailed view of the force threshold device in a starting position;

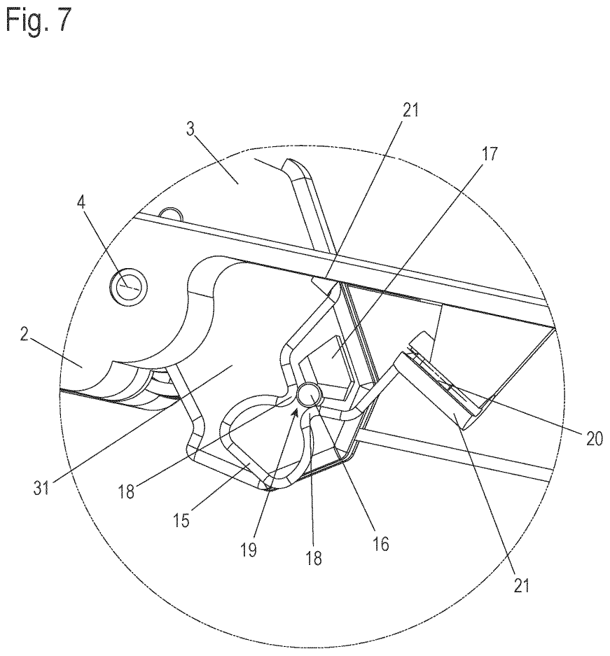

FIG. 7 shows a detailed view of the force threshold device before the driver passes through the narrowed region;

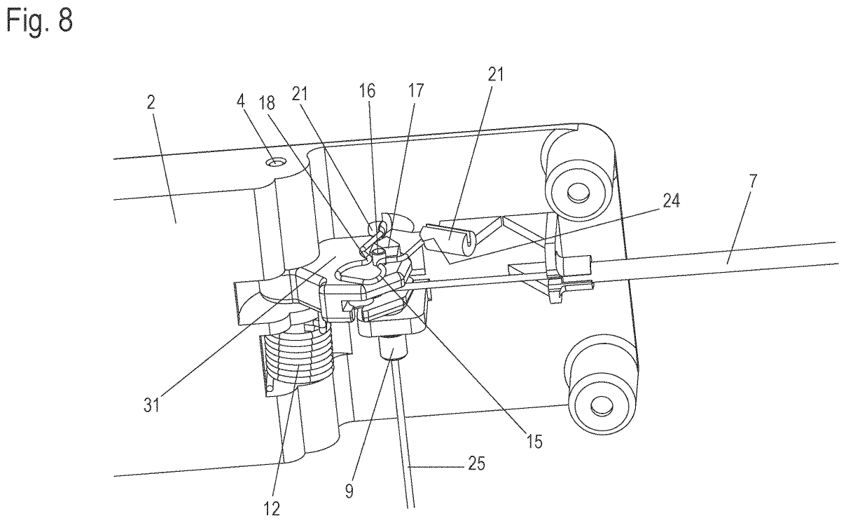

FIG. 8 shows a detailed view of the force threshold device before the driver passes through the narrowed region;

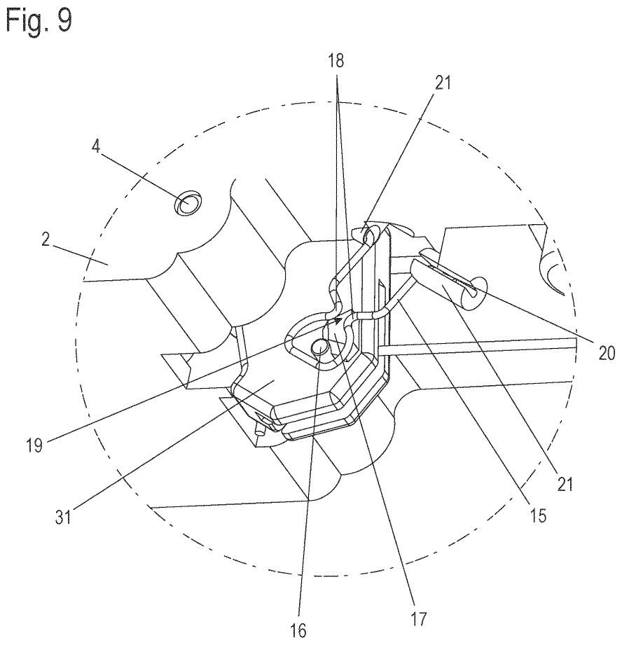

FIG. 9 shows a detailed view of the force threshold device after the driver has passed through the narrowed region;

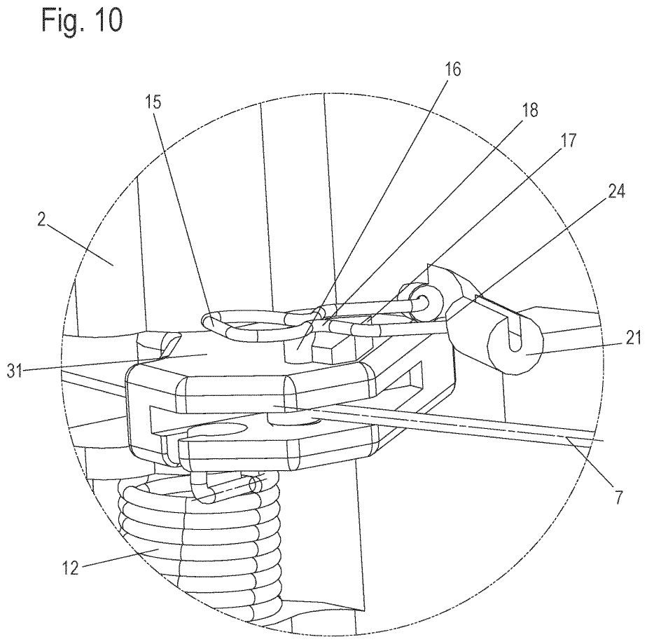

FIG. 10 shows a detailed view of the force threshold device with pivoted wire clamp;

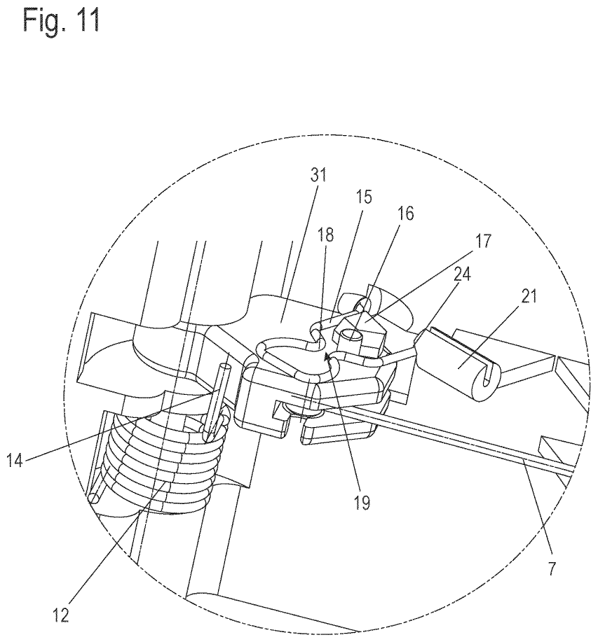

FIG. 11 shows a detailed view of the force threshold device in a starting position, and

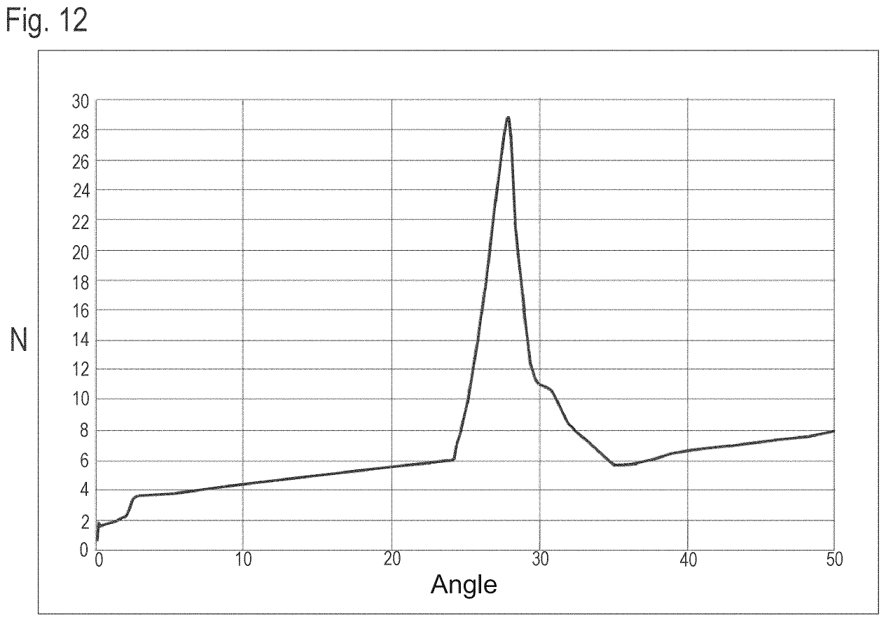

FIG. 12 shows a force-pivot path diagram showing the force required to pivot the lever.

An opening mechanism 1 comprises a bearing element 2 that can be fixed to a door leaf of a vehicle door. A lever is pivotably mounted on the bearing element 2. The lever 3 can be rotated about an axis 4 on the bearing element. A grip section of the lever 3 is arranged in a recessed grip 5 of the bearing element 2. The bearing element 2 can be fixed to a vehicle door via several screw channels 6 for fasteners. A transmission element 7 in the form of a Bowden cable, which is connected to a door lock not shown, can be moved via the lever 3. In FIG. 1A, the lever 3 is shown in a starting position on the recessed grip 5, while in FIG. 1B the lever 3 has been swung out of the recessed grip 5.

In FIG. 2A, the opening mechanism 1 is shown partially from a rear side of the bearing element 2, on which a microswitch 9 is provided. The lever 3 comprises a grip section 30 in the recessed grip 5 and, on the side opposite the axis 4, a control section 31 on which a cam 10 is formed for actuating the microswitch 9, When the lever 3 is slightly pivoted from the starting position, the cam 10, which is formed as a projection, slides along a pin 11 of the microswitch 9 on the control section 31, so that the pin 11 is moved parallel to the axis 4. This movement of the pin 11 can trigger the microswitch 9, which is connected to an electromechanical unlocking element on the door lock via a control line 25. This allows the microswitch 9 to unlock the door lock, i.e. when the lever 3 is arranged in a first pivot position.

FIG. 2B also shows that the lever 3 is pretensioned into the starting position shown in FIG. 1A via a spring 12. The spring 12 is designed as a leg spring and is supported with one leg 13 on the bearing element 2 and with the opposite leg 14 on the lever 3.

In FIGS. 3A and 3B, the opening mechanism 1 is shown in an emergency unlocking position, Le. when the lever 3 has been moved from the first pivot position further in the opening direction to a second pivot position. The cam 10 on the control section 31 has moved away from the pin 11 of the microswitch 9.

In FIG. 3B, it can be seen that the cam 10 is arranged on an upper side of the control section 31, while a wire clamp 15 of a force threshold device is arranged on the lower side. Furthermore, one end 8 of the transmission element 7 is fixed to the control section 31 in order to transmit the movement of the lever 3 to the steel cable of the Bowden cable.

FIG. 4 shows the force threshold device on the bearing element 2, The force threshold device comprises a wire clamp 15, which is fixed to the bearing element 2. A driver 16 is located on the control section 31, which is pin-shaped and protrudes above the flat surface of the control section 31, A ramp 17 is arranged behind the driver 16.

The function of the force threshold device is explained with reference to FIG. 5A to 5D:

In FIG. 5A, the lever 3 is in a starting position in which the grip section 30 is aligned essentially parallel to a surface of the bearing element 2 on the inside. From this starting position, the lever 3 can be pivoted about the axis 4 so that the driver 16 on the control section 31 is moved to a narrowed region 19 on the wire clamp 15. As soon as the driver 16 reaches the narrowed region 19, the force required to pivot the lever 3 in the opening direction increases. In this position, the user has normally unlocked the door lock via the microswitch 9 and the lever 3 can be released.

If the door lock has not been unlocked, the lever 3 is pivoted further in the opening direction, as shown in FIG. 5C. The driver 16 moves through the narrowed region 19 on the wire clamp, which is essentially Q-shaped. There is a V- or U-shaped bend on each side of the wire clamp, wherein the distance of the wire clamp in the narrowed region 19 is smaller than the width of the driver 16. As a result, the wire clamp 15 must spread open when the driver 16 passes through the narrowed region 19, which takes place with a certain amount of force depending on the selected geometry of the wire clamp 15. The thickness of the wire for the wire clamp and the lever ratios are decisive for this.

In FIG. 5D, the lever 3 has been pivoted into the second pivot position for mechanical emergency unlocking of the door lock. The driver 16 is located behind the narrowed region 19 and the wire clamp 15 has been lifted by the control section 31 by means of a guide bevel on the ramp 17.

The force threshold device is shown again in detail in the starting position in FIG. 6. The wire clamp 15 has a bent pin 20 at each of its free ends, which is held in a receptacle 21 of the bearing element 2. This allows the wire clamp 15 to be mounted simply by pressing the legs together and inserting the pins 20 into the receptacle 21. Optionally, the pins 20 can also be mounted on the receptacle 21 via a slot.

FIG. 7 shows the position of the lever 3 in which the driver 16 strikes the narrowed region 19 of the wire clamp 15. A V-shaped bend is provided on each side of the wire clamp, so that the wire clamp 15 is Q-shaped in plan view. The distance between the two tips of the V-shaped bend 18 is smaller than the diameter of the cylindrical driver 16. As a result, the wire clamp 15 has to expand when the driver 16 is passed through the narrowed region 19, which leads to increased force being applied.

Behind the driver 16, the ramp 17 is arranged with a guide bevel. This acts on the wire clamp 15 when the driver 16 arrives behind the narrowed region 19.

FIG. 8 shows the control section 31 of the lever 3, which in this illustration has the force threshold device with the wire clamp 15 and driver 16 on the upper side and the microswitch 9 on the underside, which is held on a web of the bearing element 2. It can also be seen that the wire clamp 15 rests against a slope 24 on the receptacle 21. This allows the wire clamp 15 to be pretensioned against the surface of the control section 31 on the side facing away from the receptacle 21. The free ends of the wire clamp 15 were pressed together during assembly and now each press against a slope 24, which pretensions the wire clamp 15 towards the control section 31.

FIG. 9 shows the position of the wire clamp 15 when the driver 16 has passed the narrowed region 19. Behind the driver 16 is the ramp 17 with the guide bevel, which now lifts the wire clamp 15 away from the control section 31, so that the wire clamp 15 is now positioned above the end face of the cylindrical driver 16. The raised position of the wire clamp 15 can be seen even more clearly in FIG. 10. This position corresponds to the second pivot position when the emergency unlocking has been carried out on the door lock. If the lever 3 is now to be pivoted back into the starting position, the lever 3 can be released so that it is pressed into the starting position by the force of the spring 12. During the return movement, the wire clamp 15 is initially in the raised position, so that the driver 16 is no longer passed through the narrowed region 19, but the narrowed region 19 of the wire clamp 15 is moved over the driver 16, As a result, the force threshold device is only effective in one pivoting direction towards the emergency unlocking position, while it is bypassed in the opposite direction.

When the ramp 17 and the driver 16 have passed the narrowed region 19 in the return direction, the wire clamp 15 can pivot downwards again due to the pretension towards the control section 31 and rotates around the axis formed by the pins 20. In doing so, the legs on the wire clamp move along the slope 24 and the starting position shown in FIG. 11 is reached again.

FIG. 12 shows a force-angle diagram. The angle refers to the rotational position of the lever 3, which is pivoted from a starting position of 0° into a first pivot position for triggering the microswitch 9, wherein the microswitch 9 triggers in a pivoting range between 5° and 25°, for example. The force for actuating the lever 3 increases slightly, as the spring 12, which is designed as a leg spring, is tensioned during the pivoting movement of the lever 3. At a pivot angle of the lever 3 between 20° and 35°, the force threshold device acts and a tension peak can be seen when the driver 16 is passed through the narrowed region 19. The peak corresponds to the force required to pivot the lever 3 from the first pivot position to the second pivot position. After the driver 16 has passed through the narrowed region 19, the force drops abruptly and the lever 3 can be pivoted further, essentially against the force of the spring 12. Behind the peak of the force progression through the force threshold device, the emergency unlocking means is triggered, for example in a pivoting range between 30° and 50° of the lever 3 in relation to the starting position. The force required to move the lever through the force threshold device is therefore at least three times, preferably at least four times, as high as the force required to pivot the lever to the first pivot position.

In the exemplary embodiment shown, the wire clamp 15 is fixed to the bearing element 2 and the driver 16 is fixed to the lever 3. It is of course also possible to kinematically reverse the force threshold device and provide the wire clamp 15 on the lever 3 and the driver 16 on the bearing element.

### LIST OF REFERENCE SIGNS

1 Opening mechanism
2 Bearing element
3 Lever
4 Axis
5 Recessed grip
6 Screw channel
7 Transmission element
8 End
Microswitch
10 Cam
11 Pin
12 Spring
13 Leg
14 Leg
15 Wire clamp
16 Driver
17 Ramp
18 Bend
19 Narrowed region
20 Pin
21 Receptacle
24 Slope
25 Control line
30 Grip section
31 Control section

1. An opening mechanism (1) for a vehicle door, comprising:
a bearing element (2) which is configured to be mounted on the vehicle door and has a pivotably mounted lever (3),
a microswitch (9) configured for unlocking a door lock,
a mechanical emergency unlocking means configured for unlocking the door lock, and
a force threshold device,
wherein the lever (3), which is pretensioned into a starting position, actuates the microswitch (9) in a first pivot position and actuates the mechanical emergency unlocking means in a second pivot position, and the first pivot position of the lever (3) is arranged between the starting position and the second pivot position,
wherein the force threshold device, by means of which the force for pivoting the lever (3) from the first pivot position into the second pivot position is increased, comprises a wire clamp (15) and a driver (16) movable relative to the wire clamp (15), wherein the driver (16) is configured to be passed through a narrowed region (19) on the wire clamp (15) in order to increase the force by way of the force threshold device.

2. The opening mechanism according to claim 1, wherein the force for moving the lever (3) by the force threshold device is at least three times as high as when moving from the starting position to the first pivot position.

3. The opening mechanism according to claim 1, wherein the wire clamp (15) at the narrowed region (19) has a smaller distance than a thickness of the driver (16).

4. The opening mechanism according to claim 1, wherein the wire clamp (15) is formed into an Ω.

5. The opening mechanism according to claim 1, wherein a ramp (17) with a guide bevel is arranged adjacent to the driver (16), by means of which the wire clamp (15) is movable perpendicularly to a direction of movement of the driver (16).

6. The opening mechanism according to claim 5, wherein the guide bevel is configured to bring the wire clamp (15) out of engagement with the driver (16) and the driver (16) is not passed through the narrowed region (19) during a return movement from the second pivot position to the first pivot position.

7. The opening mechanism according to claim 1, wherein the driver (16) is designed as a pin, bolt, tube section or projection.

8. The opening mechanism according to claim 1, wherein the wire clamp (15) is fixed to the bearing element (2) and the driver (16) is fixed to the lever (3).

9. The opening mechanism according to claim 8, wherein the wire clamp (15) is pretensioned towards the lever (3).

10. The opening mechanism according to claim 1, wherein the microswitch (9) is fixed to the bearing element (2) and interacts with a cam (10) on the lever (3).

11. The opening mechanism according to claim 1, wherein the lever (3) is connected to the emergency unlocking means via a transmission member (7).

12. The opening mechanism according to claim 1, wherein the wire clamp (15) has a bent pin (20) at each of its free ends, which pin is inserted into a receptacle (21) of the bearing element (2).

13. The opening mechanism according to claim 1, wherein the lever (3) is designed as a two-armed lever (3) with a grip section (30) and a control section (31).

14. A vehicle having a vehicle door and an opening mechanism according to claim 1 for opening the vehicle door.

15. A method for actuating an emergency unlocking means of an opening mechanism on a vehicle door, comprising the following steps of:
pivoting a lever (3) pivotably mounted on a bearing element (2) from a starting position against the force of a spring (12) into a first pivot position at which a microswitch (9) for unlocking a door lock can be switched;
pivoting the lever (3) from the first pivot position to a force threshold device with a wire clamp (15) and a driver (16) that can be moved relative to the wire clamp (15), wherein the driver (16) has a narrowed region (19) for increasing the resistance when the lever (3) is pivoted, through which the driver (16) is passed and which expands when the driver (16) is passed through, and
pivoting of lever (3) from the force threshold device to a second pivot position and actuating a mechanical emergency unlocking means to unlock the door lock.
